(19) United States
(12) Patent Application Publication
(10) Pub. No.: US 2017/0269194 A1
(43) Pub. Date: Sep. 21, 2017

(54) SIGNAL PROCESSING DEVICE, RADAR APPARATUS AND SIGNAL PROCESSING METHOD

(71) Applicant: KABUSHIKI KAISHA TOSHIBA, Tokyo (JP)

(72) Inventors: Koichiro GOMI, Yokohama (JP); Shigeru HIURA, Tokyo (JP); Tomomi AOKI, Yokohama (JP); Kazuaki KAWABATA, Yokohama (JP)

(73) Assignee: KABUSHIKI KAISHA TOSHIBA

(21) Appl. No.: 15/394,061

(22) Filed: Dec. 29, 2016

(30) Foreign Application Priority Data
Mar. 15, 2016 (JP) 2016-051308

(51) Int. Cl. G01S 7/35

(52) U.S. Cl. CPC G01S 7/352

(57) ABSTRACT

A signal processing device in accordance with one aspect of the present invention includes a first signal processor, a second signal processor, and a signal generator. The first signal processor is configured to generate a first signal by signal processing based on a first window function, a reference signal, and a reception signal. The second signal processor is configured to generate a second signal by signal processing based on a second window function, the reference signal, and the reception signal. The signal generator is configured to generate a third signal based on at least the first signal and the second signal.

### CROSS-REFERENCE TO RELATED APPLICATION (S)

This application is based upon and claims the benefit of priority from Japanese Patent Application No.2016-051308, filed Mar. 15, 2016; the entire contents of which are incorporated herein by reference.

### FIELD

An embodiment relates to a signal processing device, a radar apparatus and a signal processing method.

### BACKGROUND

It is desirable in a processing scheme of a radar associated with a reception signal that sidelobe levels are suppressed along a time axis while increase in an S/N (signal-to-noise ratio) loss is also suppressed. In order to realize such the processing scheme, in accordance with types of a transmission signal or pulse compression performance, an appropriate window function is generally selected from predetermined window functions or generated on an as-needed basis, and the selected or generated window function is applied to the reception signal.

However, a trade-off relationship exists between the need of reducing the sidelobe level and the need of reducing the S/N loss. Also, one single window function is applied as a reference signal. Accordingly, when a window function that causes low range sidelobe level is used, the S/N loss is increased, and when a window function that causes a low S/N loss is used, it is not possible to keep the range sidelobe level low. It is thus difficult to calculate an output value that satisfies these two needs at the same time. Hence, a window function applied at the time of pulse compression is selected by compromising with either or both the sidelobe level and the S/N loss.

### BRIEF DESCRIPTION OF THE DRAWINGS

FIG. 1A to 1D are diagrams illustrating principles of pulse compression carried out by a radar apparatus in accordance with one embodiment of the present invention;

FIG. 2 is a diagram illustrating characteristics of window functions;

FIG. 3 is a block diagram illustrating an example of an outline configuration of the radar apparatus in accordance with one embodiment of the present invention;

FIG. 4 is a block diagram illustrating an example of an outline configuration of a signal processor;

FIG. 5A and 5B are diagrams illustrating examples of signal processing results Y(t);

FIG. 6 is a diagram illustrating an example of n output signal Z(t);

FIG. 7A and 7B are diagrams illustrating examples of the signal processing results Y(t) when noise is contained;

FIG. 8 is a diagram illustrating an example of the output signal Z(t) when noise is contained;

FIG. 9 is a typical flowchart of overall processing of the radar apparatus in accordance with this embodiment;

FIG. 10 is a typical flowchart of processing of a signal processor in accordance with this embodiment; and

FIG. 11 is a block diagram illustrating an example of a hardware configuration in accordance with one embodiment of the present invention.

### DETAILED DESCRIPTION

A signal processing device in accordance with one aspect of the present invention includes a first signal processor, a second signal processor, and a signal generator.

The first signal processor is configured to generate a first signal by signal processing based on a first window function, a reference signal, and a reception signal.

The second signal processor is configured to generate a second signal by signal processing based on a second window function, the reference signal, and the reception signal.

The signal generator is configured to generate a third signal based on at least the first signal and the second signal.

In accordance with one embodiment of the present invention, a signal is generated that achieves both the reduction of the S/N loss and the suppression of the sidelobe level.

Below, a description is given of an embodiment of the present invention with reference to the drawings. The present invention is not limited to the embodiments. (An embodiment of this invention)

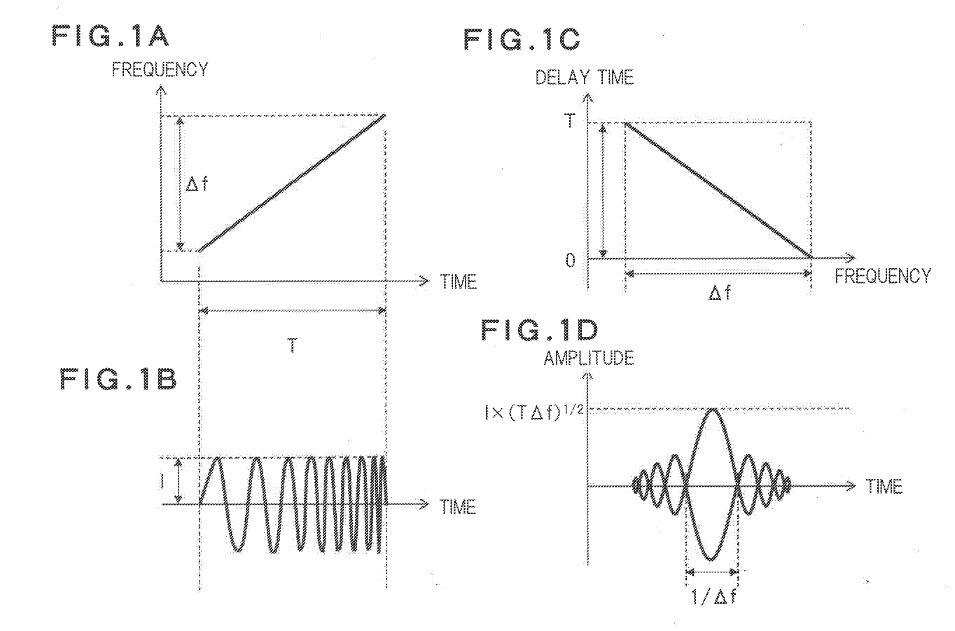

FIG. 1A to 1D are diagrams that illustrates principles of pulse compression carried out by a radar apparatus in accordance with one embodiment of the present invention.

The radar apparatus in accordance with one embodiment of the present invention identifies a position of an observation object (i.e., a target) based on a time interval between a time at which a radio wave (i.e., a transmission wave) is transmitted and a time at which a reflected wave of this radio wave from the observation object is received. The observation object is not limited to a particular one. It may be a human, an animal, an artificial object such as an airplane and a ship, or a meteorological phenomenon such as a cloud, rain, and snow. Identification of the position of a cloud or the like enables prediction of future meteorological phenomena.

“Pulse compression” as used herein is a process of improvement of resolution with respect to an observation distance of the radar apparatus and suppression of reduction in a detection distance. Pulse compression refers to a process for compression in terms of time of the reception signal with respect to a frequency-modulated transmission signal. FIGS. 1A and 18 illustrate a transmission signal (chirp signal) generated by subjecting a pulse signal for transmission to frequency modulation. FIG. 1A illustrates transition of the frequency of the transmission signal. As time passes, the frequency of the transmission signal is increased, FIG. 1B illustrates a waveform of the transmission signal. As time passes, a wavelength of the transmission signal is decreased. In the case of a radar apparatus that performs pulse compression, the pulse signal is typically subjected to frequency modulation that linearly change a pulse signal by a frequency having a sweep width Δf for a constant time width T.

FIG. 1C illustrates content of the pulse compression carried out for the reception signal. Pulse compression is a process that gives the reception signal a time delay in accordance with the frequency thereof. As the frequency is increased, the given time delay becomes shorter. FIG. 1D illustrates an output waveform of the reception signal that has been subjected to the pulse compression. The pulse width of the reception signal after the puke compression is compressed to 1/Δf, which represents a reciprocal of the sweep width Δf, independently of the original pulse width T. In other words, since the pulse width of the output waveform is compressed to T×Δf times, a distance resolution in a range direction can be increased by T×Δf times. Note that amplitude (level) will be (TΔf)^{1/2} times.

Meanwhile, as illustrated in FIG. 1D, a false image called “range sidelobe” appears in the pulse-compressed output waveform. The range sidelobe leads to erroneous detection of the observation object or degradation of radar performance. In order to reduce the level of the range sidelobe (range sidelobe level), weighting of the amplitude by a window function is carried out in advance for the reference signal used in the pulse compression in the interval of the pulse width T. The range sidelobe level can be kept low by performing pulse compression using the reference signal to which this window function is applied.

However, since application of the window function leads to generation of an S/N loss, performance as a radar is degraded. Also, a trade-off relationship exists between this S/N loss and the range sidelobe level, so that keeping the S/N loss low leads to increase in the range sidelobe level whilst keeping the range sidelobe level low tends to cause increase in the S/N loss.

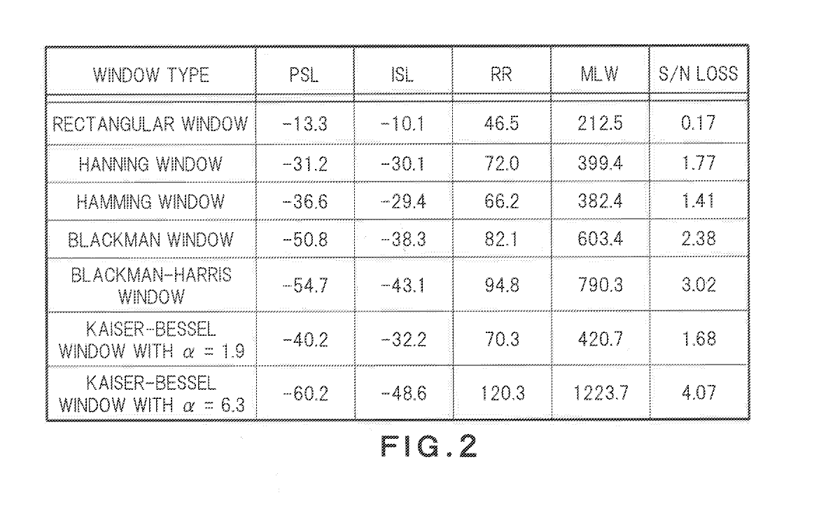

FIG. 2 is a diagram that illustrates characteristics of window functions. An example of a window function for use in the radar apparatus, a maximum value of the range sidelobe level when this example window function is applied (Peak Sidelobe Level; PSL), and a value of the S/N loss are indicated in each row of the table of the FIG. 2 By using the PSL as a guide, an amount of increase and decrease in the range sidelobe level can be recognized.

It should be noted that the window functions illustrated in FIG. 2 are merely examples and other window functions may be used. Also, the individual values illustrated in FIG. 2 are values calculated under assumption of the pulse width T=58 μs, the frequency bandwidth Δf=1.5 MHz, and a raised cosine roll-off rate=10%. The raised cosine is a window function used in waveform shaping of the transmission signal. These presupposed values for calculation of the individual values indicated in FIG. 2 may be freely defined as appropriate.

As illustrated in FIG. 2, the amounts of the range sidelobe levels and the S/N losses vary depending on the window functions to be applied. However, it can be appreciated that it is difficult to keep the S/N loss low while keeping the range sidelobe low as long as one single window function is applied. When the value of the raised cosine is adjusted, the differences in the characteristics among the window functions will become further conspicuous.

It should be noted that FIG. 2 indicates, as characteristics of the output waveform other than the PSL, ISL (Integrated Sidelobe Level) which represents a level ratio of an integration amount of the sidelobe to a main lobe, RR (Range Resolution) which represents a distance resolution, and a width of the main lobe (MainLobe Width; MLW). These characteristics of the output waveform other than the PSL may also be taken into consideration.

It should be noted that in the case of the Kaiser-Bessel window, it is possible to change the shape of the window function by the real number parameter a of the Kaiser-Bessel function. When the shape of the window function is adjusted, the relationship between the characteristics of the output waveform and the S/N loss can be adjusted. For example, if the real number parameter α=1.9, then the value of the S/N loss is as small as 68 dB whilst the PSL becomes as large as −40,2 dB, Meanwhile, if the real number parameter α=6.3, then the value of the S/N loss becomes as large as 4.07 dB, but the PSL can be kept low to be −60.2 dB.

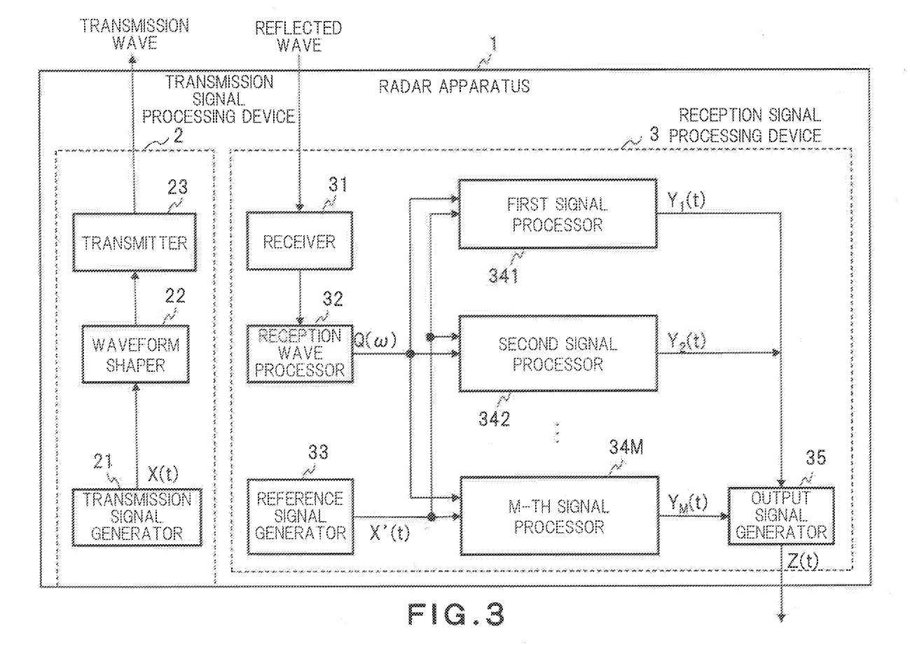

FIG. 3 is a block diagram that illustrates an example of an outline configuration of the radar apparatus in accordance with one embodiment of the present invention. The radar apparatus in accordance with a first embodiment includes a transmission signal processing device 2 and a reception signal processing device 3. The transmission signal processing device 2 includes a transmission signal generator 21, a waveform shaper 22, and a transmitter 23. The reception signal processing device 3 includes a receiver 31, a reception wave processor 32, a reference signal generator 33, a signal processor 34, and an output signal generator 35.

Although first to M-th (where “M” is an integer equal to or larger than 2) signal processors 34 are illustrated in FIG. 3, the number of the signal processors 34 to be provided corresponds to the number of signal processing results to be generated. It suffices that at least two signal processors, i.e., the first signal processor 341 and the second signal processor 342 are provided. Although details will be described later, the window functions used in the signal processing by the individual signal processors 34 all differ from each other, different signal processing results can be obtained using different window functions as long as at least two signal processors are provided And an output signal can be obtained on the basis of the different signal processing results. For example, when one of the two different window functions is a window function associated with a small S/N loss value and the other is adapted to lower the sidelobe level, then it is made possible to obtain an output result that achieves both reduction in the S/N loss and suppression of the sidelobe level.

The transmission signal processing device 2 is configured to generate a transmission wave to be radiated toward an observation object. The transmission signal generator 21 in the transmission signal processing device 2 is configured to generate a predetermined transmission signal obtained by subjecting a square pulse wave to frequency modulation. A pulse width of the transmission signal, a modulation bandwidth, and the like may be defined prior to generation of the transmission signal. Here, this transmission signal is expressed by a function X(t) at a time t.

The waveform shaper 22 is configured to carry out predetermined weighting for a time response amplitude waveform of the generated transmission signal, which enables to suppress spreading of a frequency spectrum of the transmission wave and reduce the range sidelobe at the time of pulse compression. As an example of the weighting function on the time axis to be applied to the transmission signal, raised cosine (Tuley window) may be listed. Spreading of the frequency spectrum can be suppressed by multiplying the transmission signal with the raised cosine. The window function W^{t}(t) of the raised cosine is expressed by the following expression using the pulse width “T” of the transmission signal and a ratio “r” of the taper portion of the window.

$$\begin{matrix}[ Expression 1 ] & \\ {W}^{t} ( t ) = \{ \begin{matrix}\frac{1}{2} \{ 1 + cos ( \frac{2 π}{r} [ t + \frac{T}{2} - \frac{r}{2} ] ) \} & - \frac{T}{2} \leq t < - \frac{T}{2} + \frac{r}{2} \\ \frac{1}{2} \{ 1 + cos ( \frac{2 π}{r} [ t + \frac{T}{2} - \frac{r}{2} ] ) \} & \frac{T}{2} - \frac{r}{2} \leq t < \frac{T}{2}\end{matrix} , & ( 1 )\end{matrix}$$

Note that the value of the ratio “r” is generally specified to be in the order of 0.1 to 0.2.

The transmitter 23 is configured to transmit via a not-shown antenna a shaped transmission signal put on the radio wave (transmission wave). It should be noted that an existing transmission device for pulse compression may be used as the transmission signal processing device 2.

The reception signal processing device 3 obtains a reflected wave generated as a result of reflection of the transmission wave by the observation object and carries out multiple types of pulse compression for the signal on the reflected wave (reception signal). The multiple types of pulse compression mean a plurality of pulse compressions where different window functions are applied respectively. By carrying out the multiple types of the pulse compressions, multiple pulse compression results having different characteristics of the output waveform are obtained. In addition, one output signal is generated on the basis of the multiple pulse compression results.

Meanwhile, for example, when a Kaiser-Bessel window with a real number parameter α=1.9 is used in one pulse compression, a Kaiser-Bessel window with a real number parameter α=6.3 may be used in another pulse compression. In a case of a window function that can change the characteristics of the output waveform by changing the value of the parameter like the Kaiser-Kessel window, if the values of the parameters are different, they are regarded as different window functions. It should be noted that the value of the real number parameter α may be freely adjusted.

The receiver 31 is configured to obtain a reception signal contained in the reflected wave. Although this embodiment assumes that the reception signal processing device 3 obtains the reception wave and extracts the reception signal, the receiver 31 may obtain the reception signal from an external device that extracted the reception signal.

The reception wave processor 32 is configured to convert the reception signal obtained by the receiver 31 into a frequency spectrum signal by performing Fourier transform for the reception signal in order that the pulse compression can be carried out. The reception signal that has been subjected to the Fourier transform is expressed by the function Q(ω) at angular frequency “Ω.” It should be noted that Q(ω) may be obtained by convolutional integration. The convolutional integration also applies to the other processes involve Fourier transform.

The reference signal generator 33 is configured to generate a reference signal. It is assumed here that the reference signal is either identical to the transmission signal X(t) generated by the transmission signal generator 21 or the transmission signal converted to sampling rate of the receiver 31. The reference signal is expressed by X′(t). The reference signal X′(t) is delivered to the individual signal processors 34.

Each of the signal processors 34 is configured to generate a signal processing result on the basis of the reference signal X′(t), the reception signal Q(ω), and corresponding the window function specified for each of the signal processors 34. Here, the signal processing result is expressed by the function Y(t) at the time “t.” The window function is expressed by the function W^{r}(t) at the time “t.” Also, when the functions of the individual signal processors 34 should be distinguished from each other, an index indicative of an identification number of each signal processor 34 is used. For example, the window function of the first signal processor 341 is expressed by W^{r}₁(t). The output result of the second signal processor 342 is expressed by Y₂(t). The signal processing result of the m-th (where “m” is an integer not less than 1 and not more than “M”) signal processor 34 is expressed by Yₘ(t).

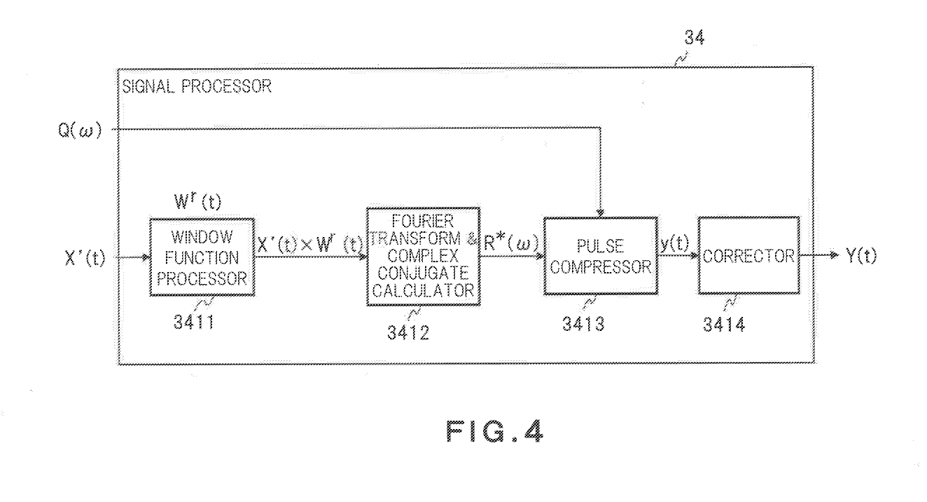

FIG. 4 is a block diagram that illustrates an example of an outline configuration of the signal processor 34. The signal processor 34 includes a window function processor 3411, a Fourier transform and complex conjugate calculator 3412, a first pulse compressor 3413, and a first corrector 3414.

The window function processor 3411 of the signal processor 34 is configured to multiply the reference signal X′(t) by the window function W^{r}(t). It is assumed here that the window function W^{r}(t) is specified in advance for each window function processor 3411 before processing by the window function processor 3411 is carried out.

It may also be possible that the window function specified in the window function processor 3411 can be changed by a user or another system via a not-shown input device. Also, a condition may be specified and the window function processor 3411 may select a window function that satisfies the specified condition.

Meanwhile, overlap of the window functions used by the window function processors 3411 of the individual signal processors 34 generates the same signal processing results Y(t). Hence, it must be ensured that the window functions used by the window function processors 3411 of the individual signal processors 34 are all different from each other. Thereby, it is made possible to obtain signal processing results Y(t) that are always different from each other.

Also, in order to obtain desired signal processing results Y(t), it is necessary that appropriate window functions W^{r}(t) are specified. For example, suppose a case where the first signal processor 341 generates a signal processing result Y₁(t) suppressing the S/N loss and the second signal processor 342 generates a signal processing result Y₂(t) reducing the range sidelobe level. In this case, a window function with the S/N loss value not more than 2 dB is specified as the window function suppressing the S/N loss whilst a window function causing the PSL to be equal to or less than −50 dB is specified as the window function reducing the range sidelobe level. As a result, candidates of the window function to be used by the first window function processor 3411 will be a rectangular window, a Hanning window, and a Hamming window as illustrated in FIG. 2. Also, candidates of the window function to be used by the second window function processor 3411 will be a Blackman window, a Blackman-Harris window, a Kaiser -Bessel window with the real number parameter α=6.3 as illustrated in FIG. 2. In this manner, a condition that the first window function has an S/N loss lower than a first reference value, a condition that the second window function has a PSL equal to or lower than a second reference value (the range sidelobe level is made to be lower than the second reference value), and/or other conditions are defined, and an appropriate window function that satisfies the condition(s) is specified for the window function processor 3411.

The Fourier transform and complex conjugate calculator 3412 is configured to carry out Fourier transform and complex conjugation for the signal X′(t)×W^{r}(t) obtained by multiplying the reference signal X′(t) with the window function W^{r}(t), and to generate a signal R*(ω) by which the reception signal Q(ω) is to be multiplied. R*(ω) represents a complex conjugate of the R(ω). The R(ω) represents a signal obtained by subjecting the signal X′(t)×W^{r}(t), which is obtained by multiplying the reference signal X′(t) with the window function W^{r}(t), to the Fourier transform.

The puke compressor 3413 is configured to carry out pulse compression using, as inputs, the signal R*(ω) generated by the window function processor 3411 and the reception signal Q(ω), and to generate a generation signal y(t). The specific processing of the pulse compression includes multiplying the reception signal Q(ω) by the signal R*(ω) generated by the window function processor 3411 and carrying out inverse Fourier transform.

The corrector 3414 is configured to carry out correction of the generation signal y(t) resulting from the pulse compression to correct the S/N loss due to application of the window function and generate the signal processing result Y(t). By correcting the S/N loss due to the window function, the peak levels of the main lobes to be observed in the individual signal processing results Y(t) can be aligned. Thereby, it is made possible for the output signal generator 35 to compare a plurality of the signal processing results Y(t).

The corrector 3414 determines a value for correction (loss correction value) in accordance with the window function applied by the window function processor 3411. The calculation method of the loss correction value should be defined in advance. An example of the calculation method of the loss correction value may be expressed by the following expression.

$$\begin{matrix}[ Expression 2 ] & \\ Loss correction value = 10 log [ \frac{{( {\sum }_{n = 1}^{N} {W}_{n}^{r} )}^{2}}{N \{ {\sum }_{n = 1}^{N} {( {W}_{n}^{r} )}^{2} \}} ] & ( 2 )\end{matrix}$$

where “N” represents the length of the window function, “n” represents a number indicated interval of the divided window function when the length “N” of the window function is divided by a length between −T/2 and T/2, and W^{r}ₙ is an average value of the window function W^{r}(t) in the interval “n.”

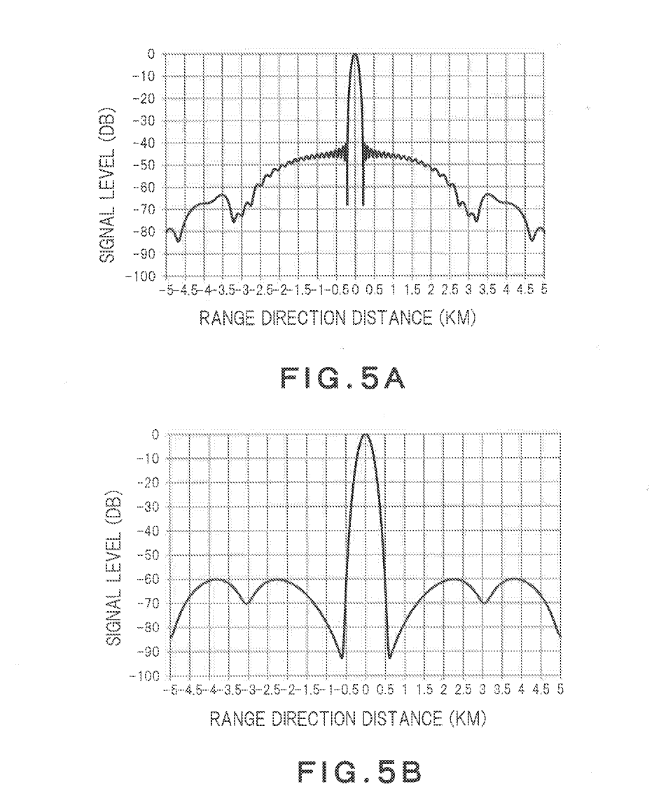

FIG. 5A and 5B that illustrate examples of the signal processing results Y(t). FIG. 5A illustrates the signal processing result Y₁(t) of the first signal processor 341 in a case where the Kaiser-Bessel window function with the real number parameter α=1.9 is applied to the first window function processor 3411 as the window function reducing the S/N loss. FIG. 5B illustrates the signal processing result Y₂(t) of the second signal processor 342 in a case where the Kaiser-Bessel window function with the real number parameter α=6.3 is applied to the second window function processor 3411 as the window function reducing the range sidelobe level. The horizontal axis represents a relative distance with respect to the observation object in the range direction of the beam transmitted by the radar, the relative distance being obtained by conversion of time.

The signal processing result Y₁(t) has a main lobe whose width is smaller than that of the signal processing result Y₂(t). Since a smaller main lobe width corresponds to higher resolution, the signal processing result Y₁(t) identifies the position of the observation object more accurately than the signal processing result Y₂(t). Meanwhile, as can be appreciated from the fact that the level is −50 db or more in the range between minus 2.5 km and plus 2.5 km from the range direction distance 0 to be referenced, the signal processing result Y₁(t) has a sidelobe level higher than that of the signal processing result Y₂(t). Hence, even when a signal exists at a location near the sidelobe, it is not possible to detect this signal. In other words, the signal processing result Y₁(t) exhibits more degraded observation performance to observe the observation object and surrounding area thereof.

The output signal generator 35 is configured to generate an output signal Z(t) based on the signal processing results Y(t) of the individual signal processors 34. The output signal generator 35 defines, for example, the S/N loss as a reference item and generates a combined signal combining signal processing results Y(t) having the lowest S/N loss in a time series (at a certain time), and the combined signal may be defined as the output signal Z(t). Also, on the basis of a predetermined condition, one result may be selected from all the signal processing results Y(t) and the one selected signal processing result Y(t) may be defined as the output signal Z(t).

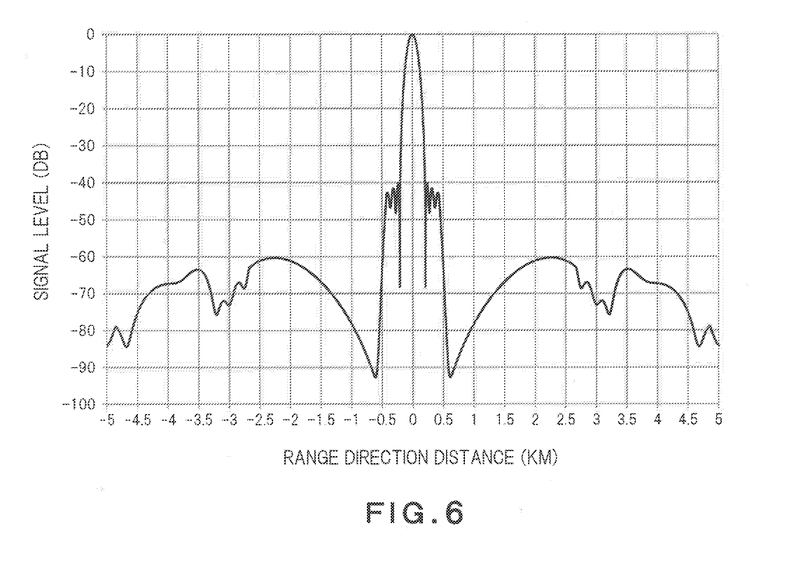

FIG. 6 is a diagram that illustrates an example of the output signal Z(t). The output signal Z(t) of FIG. 6 is generated on the basis of the signal processing result Y₁(t) illustrated in FIG, 5A and the signal processing result Y₂(t) illustrated in FIG. 5B. In the example of FIG. 6, the output signal generator 35 defines the signal level as the selection criterion and selects one signal processing result with the lower signal level of the results Y₁(t) and Y₂(t) in the time series. Thereby, the signal level of the output signal Z(t) is not more than the signal level of the signal processing result Y₁(t) and not more than the signal level of the signal processing result Y₂(t) in the predetermined distance (period) illustrated in FIG. 6. Accordingly, it is made possible to obtain an output signal having a narrow main lobe width and a low side main lobe level.

Although the signal level of the output signal Z(t) in FIG. 6 is equal to the signal level of either one of the two signal processing results Y₁(t) and Y₂(t), the signal does not need to be equal to either one of them. The output signal generator 35 may adjust the signal level of the output signal Z(t).

Although the output signal Z(t) in FIG. 6 is generated on the basis of the two results, i.e., the signal processing results Y1(t) and Y2(t), the output signal Z(t) will be generated also taking into account another signal processing result or results Y(t) other than the signal processing results Y₁(t) and Y₂(t) if three or more signal processors 34 are provided.

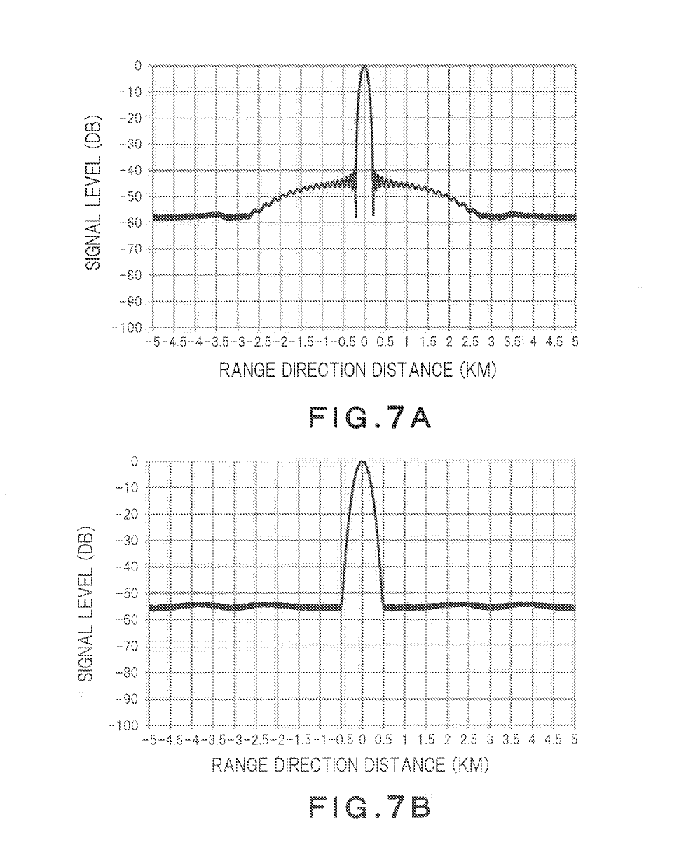

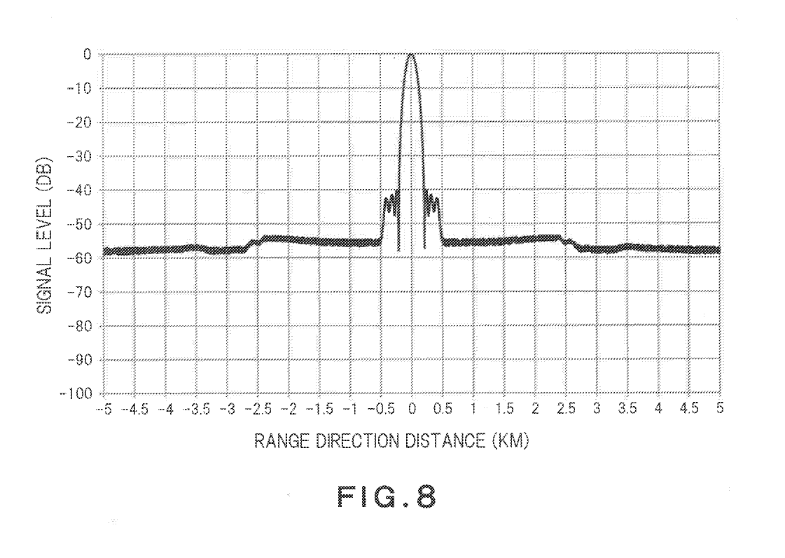

In this embodiment, the intended effect can be obtained even when noise exists. FIG. 7A and 7B are diagrams that illustrate examples of the signal processing results Y(t) when noise is contained. FIG. 8 is a diagram that illustrates an example of the output signal Z(t) when noise is contained.

Specifically, FIG. 7A and 7B illustrate the signal processing results Y₁(t) and Y₂(t) in a case where thermal noise of the same level is applied to the signal processing results y₁(t) and y₂(t) generated by the pulse compressor 3413. Presence of the thermal noise indicates that, in contrast to FIG. 5, there is an output in the level between −50 dB and −60 dB even the distance from the observation object is large.

In the output signal Z(t) illustrated in FIG. 8, in the same or similar manner as in the example of FIG. 6, the signal level is defined as the selection criterion and the signal processing result Y(t) having the lower level in the time series is selected. The output signal Z(t) of FIG. 8 has a low signal level in the noise floor portion. In this manner, the output signal Z(t) that keeps the S/N loss low is generated even when noise exists.

It should be noted in the examples of FIGS. 6 and 8 that the output signal generator 35 defines the signal level as the selection criterion and selects the signal processing result having a lower signal level. Meanwhile, in a case where there are multiple observation objects in the observation range, it may happen that the multiple observation objects cannot be recognized when the sidelobe level is large. Thus, in order to respond to a case where multiple observation objects exist and an error in the signal processing result Y(t) becomes large, the output signal generator 35 may divide in advance the range direction into multiple intervals as follows and determine the signals to be selected on a per-interval basis.

For example, in an interval where the distance from the radar apparatus is short (the interval of 0≦t≦Ta, where Ta is a constant), the output signal generator 35 selects a signal processing result Y(t) with a window function being applied that causes the range sidelobe to become small even when the S/N loss is large in order to make the multiple observation objects recognizable. Meanwhile, in an interval where the distance from the radar apparatus is long (Ta<t≦Tb, where Tb is a constant), since the level of the reception signal is decreased, the output signal generator 35 selects a signal processing result Y(t) with a window function being applied that has a small S/N loss even when the range sidelobe is slightly large. The reference value Ta of the distance should be adjusted as appropriate in accordance with the system design of the radar. Even in this case, three or more window functions may be used and also the number of the intervals to switch the signal processing results may be increased in accordance with the number of the window functions.

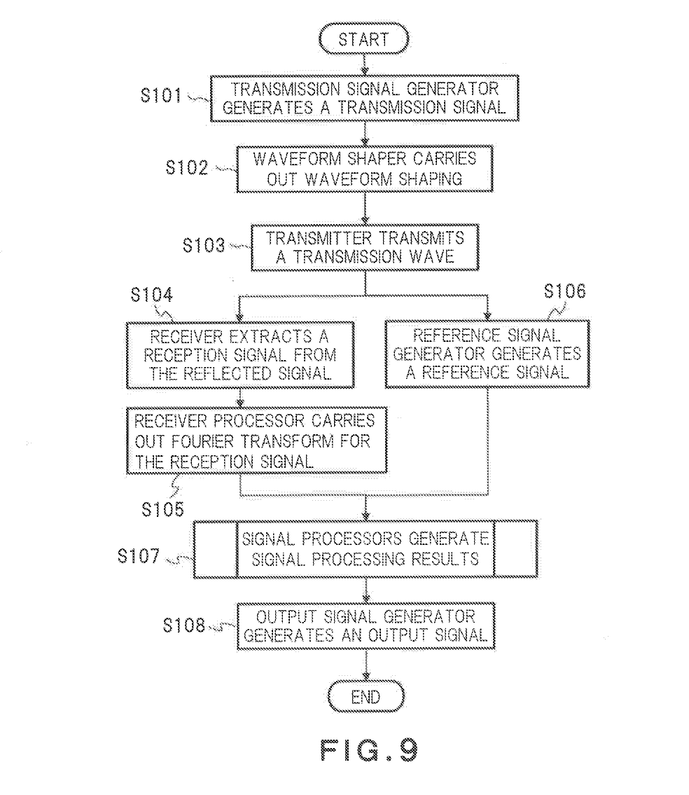

FIG. 9 is a typical flowchart of the overall processing of the radar apparatus in accordance with this embodiment. This flow is started at a predetermined time or when an instruction to start the processing has been received.

The transmission signal generator 21 generates a predetermined transmission signal X(t) (S101). The transmission signal is sent to the waveform shaper 22. The waveform shaper 22 carries out waveform shaping by weighting along the time axis for the transmission signal (S102). The waveform-shaped transmission signal is sent to the transmitter 23. The transmitter 23 converts frequency of the transmission signal into RF (Radio Frequency) and carries out power amplification, and then transmits the transmission signal as the transmission wave via an antenna (S103).

When the receiver 31 has obtained the reflected wave of the transmission wave, the receiver 31 extracts the reception signal from the reflected wave (S104). The extracted reception signal is sent to the processor of the receiver 31. The processor of the receiver 31 carries out Fourier transform for the reception signal and generates the reception signal Q(ω) (S105).( The reception signal Q(ω) is sent to each signal processor 34.

In the meantime, the reference signal generator 33 generates the reference signal X′(t) (S105). The generated reference signal X′(t) is sent to each signal processor 34. The transmission signal generator 21 may send the transmission signal to each signal processor 34 as the reference signal.

Each signal processor 34 which has received the reference signal X′(t) and the reception signal Q(ω) carries out processing for generation of the signal processing result Y(t) (S107). The flow of the processing inside of the signal processor 34 will be described later. The signal processing results Y₁(t) to Y_{M}(t) are sent to the output signal generator 35.

The output signal generator 35 generates the output signal Z(t) on the basis of the signal processing results Y1(t) to Y_{M}(t) (S108). The output signal Z(t) is output by a not-shown output device or the like. The output method is not limited to a particular one and the output signal Z(t) may be output as an image or a file. The destination of the output is not limited to a particular one. The output signal Z(t) may be output on an image display device or into a storage device that stores files. This is the typical flow of the overall processing of the radar apparatus.

It should be noted that the above-described flowchart is merely an example and the flow of processing is not limited to the illustrated one. For example, the processing step S106 may be carried out in parallel with the processing steps S101 to S103.

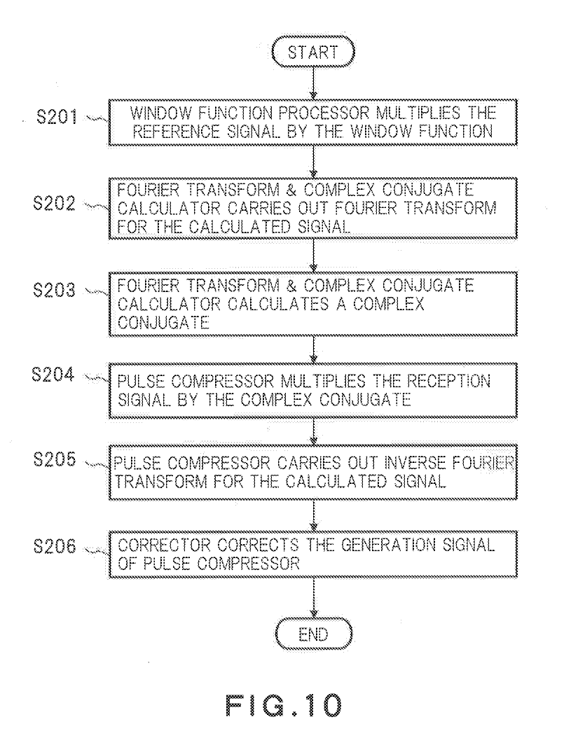

FIG. 10 is a typical flowchart of the processing of the signal processor 34 in accordance with this embodiment. This flow is started when the signal processor 34 has received the reference signal X′(t) and the reception signal Q(ω).

The window function processor 3411 multiplies the obtained reference signal X′(t) by the window function W^{r}(t) (S201). The calculated signal X′(t)×W^{r}(t) is sent to the Fourier transform and complex conjugate calculator 3412. The Fourier transform and complex conjugate calculator 3412 carries out Fourier transform for the calculated signal X′(t)×W^{r}(t) and obtains the frequency spectrum signal R(ω) (S202). In addition, the Fourier transform and complex conjugate calculator 3412 calculates the complex conjugate R*(ω) of the R(ω) (S203). The calculated complex conjugate R*(ω) is sent to the pulse compressor 3413.

The pulse compressor 3413 multiplies the obtained reception signal Q(ω) by the obtained complex conjugate R*(ω) (S204). The pulse compressor 3413 carries out inverse Fourier transform for the calculated signal Q(ω)×R*(ω) and generates the generation signal y(t) by pulse compression (S205).

The corrector 3414 corrects the generation signal y(t) by pulse compression and generates the signal processing result Y(t) (S206). The signal processing result Y(t) is sent to the output signal generator 35. This is the typical flow of the overall processing of the signal processor 34.

As described above, in accordance with this embodiment, the output signal is generated on the basis of the multiple signal processing results by multiple pulse compressions using different window functions. Use of appropriate window functions enables generation of a signal that achieves both the reduction of the S/N loss and the suppression of the sidelobe level.

Each process in the embodiment described above can be implemented by software (program). Thus, the embodiment described above can be implemented using, for example, a general-purpose computer apparatus as basic hardware and causing a processor mounted in the computer apparatus to execute the program.

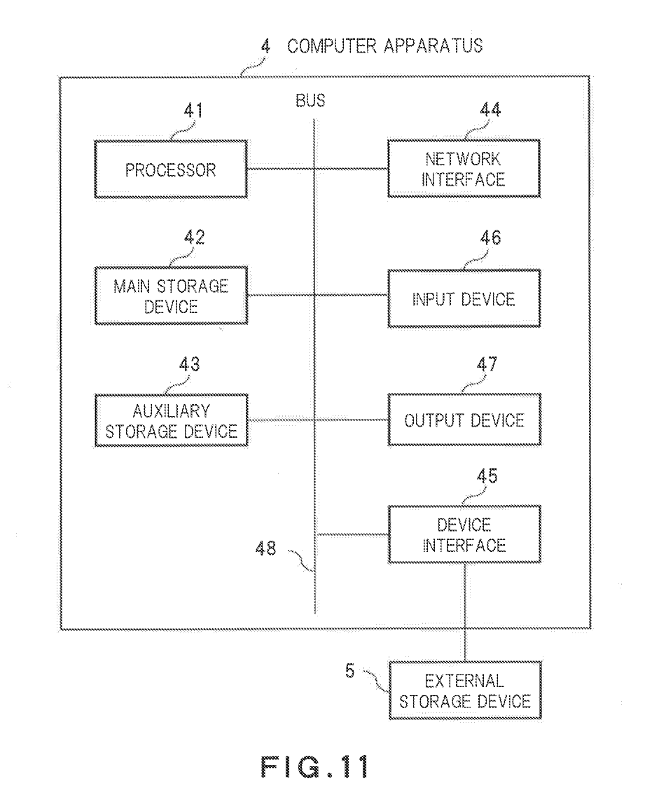

FIG. 11 is a diagram that illustrates an example of a hardware configuration in accordance with one embodiment of the present invention. The radar apparatus 1, the transmission signal processing device 2, and the reception signal processing device 3 can be implemented as a computer apparatus 4 that includes a processor 41, main storage device 42, auxiliary storage device 43, a network interface 44, a device interface 45, an input device 46, and an output device 47, which are interconnected via a bus 48.

The functions of the transmission signal generator 21, the waveform shaper 22, the reception wave processor 32, the reference signal generator 33, the signal processor 34, the window function processor 3411, the Fourier transform and complex conjugate calculator 3412, the pulse compressor 3413, the corrector 3414, and the output signal generator 35 can be realized by the processor 41 reading programs from the auxiliary storage device 43, loading the read programs onto the main storage device 42, and thus executing the loaded programs.

The processor 41 is an electronic circuit that includes a control device and an arithmetic unit of the computer. For example, a general purpose processor, a central processing unit (CPU), a microprocessor, a digital signal processor (DSP), a controller, a microcontroller, a state machine, an application specific integrated circuits (ASIC), a field programmable gate array (FPGA), a programmable logic device (PLD), and a combination thereof may be used to configure the processor 41.

The radar apparatus 1, the transmission processing device 2, and the reception processing device 3 in accordance with this embodiment may be configured by installing in advance programs to be executed by each device on the computer apparatus, or may be configured by storing the programs in a storage medium such as CD-ROM or distributing the programs via a network and installing the programs as appropriate on the computer apparatus.

The main storage device 42 is a memory device that temporarily stores instructions to be executed by the processor 41, various pieces of data, etc. The main storage device 42 may be volatile memory such as DRAM or non-volatile memory such as MRAM. The auxiliary storage device 43 is a storage device that permanently stores programs, data, etc. For example, the auxiliary storage device 43 may be flash memory or the like.

The network interface 44 is an interface for establishing wired or wireless connections to communication networks. Output results and the like may be transmitted via the network interface 44 to other communication devices. Although only one network interface 44 is illustrated in the illustrated example, multiple network interfaces 44 may be incorporated.

The device interface 45 is an interface such as USB for establishing connections to an external storage medium 5 which records the output results and the like. The external storage medium 5 may be any suitable storage medium such as an HDD, CD-R, CD-RW, DVD-RAM, DVD-R, a storage area network (SAN). Also, a not-shown external device or the like may be connected via the device interface 45.

The input device 46 is a device for inputting information in the computer. For example, the input device 46 may include, but not limited to, a keyboard and a mouse. A user is allowed to input window functions to be used and the like by using the input device 46.

The output device 47 is a device for outputting the output results. For example, the output device 47 may be a device for displaying images or a device for outputting sounds. The output device 47 may include, but not limited to, a LCD (liquid crystal display), a CRT (cathode-ray tube), a PDP (plasma display panel), and a speaker. The output signal and the like of the output signal generator 35 can be confirmed by the output device 47.

The main storage device 42 is a memory device that temporarily stores instructions to be executed by the processor 41, various pieces of data, etc., which may be volatile memory such as DRAM or non-volatile memory such as MRAM. The auxiliary storage device 43 is a storage device that permanently stores programs, data, etc. which may be, for example, an HDD, an SSD, or the like.

Also, the radar apparatus, the transmission signal processing device 2, and the reception signal processing device 3 may be configured by dedicated hardware such as a semiconductor integrated circuit or the like incorporating the processor 41.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A signal processing device comprising:
a first signal processor configured to generate a first signal by signal processing based on a first window function, a reference signal, and a reception signal;
a second signal processor configured to generate a second signal by signal processing based on a second window function, the reference signal, and the reception signal; and
a signal generator configured to generate a third signal based on at least the first signal and the second signal.

2. The signal processing device as set forth in claim 1, wherein the first signal processor and the second signal processor further include:
a window function processor configured to generate a fourth signal, the fourth signal being generated by multiplying the reference signal by a specified window function;
a Fourier transform and complex conjugate calculator configured to calculate a complex conjugate of a frequency spectrum in the fourth signal;
a pulse compressor configured to carry out pulse compression on the basis of the complex conjugate of the fourth signal and the reception signal, and to generate a fifth signal; and
a corrector configured to carry out correction of the fifth signal in accordance with the specified window function.

3. The signal processing device as set forth in claim 1, wherein the signal generator is configured to generate the third signal having a signal level, in a predetermined period, not more than a signal level of the first signal and not more than a signal level of the second signal.

4. The signal processing device as set forth in claim 1, wherein the signal generator is configured to generate the third signal having a signal level equals to the smaller value of the signal level of the first signal and the signal level of the second signal at each time point in a predetermined period.

5. The signal processing device as set forth in claim 1, wherein the first window function has an S/N loss value smaller than a first reference value, and
the second window function lowers a range sidelobe level so that the range sidelobe level is lower than a second reference value.

6. The signal processing device as set forth in claim 1, wherein the first window function has an SIN loss value lower than that of the second window function, and
the second window function lowers a range sidelobe level than when the first window function is applied.

7. The signal processing device as set forth in claim 1, wherein the signal generator generates the third signal by selecting the second signal before or at a predetermined time and selecting the first signal after the predetermined time.

8. The signal processing device as set forth in claim 1, wherein the first window function and the second window function are each selected from the group consisting of a hanning window function, a hamming window function, a Blackman window function, a Blackman-Harris window function, and a Kaiser-Bessel window function.

9. A radar apparatus comprising:
a transmission signal generator configured to generate a frequency-modulated transmission signal;
a waveform shaper configured to carry out waveform shaping for the transmission signal;
a transmitter configured to transmit the frequency-modulated transmission signal;
a first signal processor configured to generate a first signal by signal processing based on a first window function, a reference signal, and a reception signal;
a second signal processor configured to generate a second signal by signal processing based on a second window function, the reference signal, and the reception signal; and
a signal generator configured to generate a third signal based on at least the first signal and the second signal,
wherein the reception signal being a signal having a frequency spectrum associated with a reflected wave of the frequency-modulated transmission signal, and the reference signal being a signal identical with the transmission signal.

10. A signal processing method for causing performed by a computer, the method comprising:
generating a first signal by signal processing based on a first window function, a reference signal, and a reception signal;
generating a second signal by signal processing based on a second window function, the reference signal, and the reception signal; and
generating a third signal based on at least the first signal and the second signal.
